(19) United States
(12) Patent Application Publication
(10) Pub. No.: US 2024/0134171 A1
(43) Pub. Date: Apr. 25, 2024

(54) OPTICAL IMAGING SYSTEM

(71) Applicant: SAMSUNG ELECTRO-MECHANICS CO., LTD., Suwon-si (KR)

(72) Inventors: Phil Ho JUNG, Suwon-si (KR); Tae Yeon LIM, Suwon-si (KR); Yong Joo JO, Suwon-si (KR)

(73) Assignee: SAMSUNG ELECTRO-MECHANICS CO., LTD., Suwon-si (KR)

(21) Appl. No.: 18/193,260

(22) Filed: Mar. 29, 2023

(30) Foreign Application Priority Data
Oct. 23, 2022 (KR) 10-2022-0137687

(51) Int. Cl. G02B 15/14; G02B 13/00

(52) U.S. Cl. CPC G02B 15/143105; G02B 13/0035

(57) ABSTRACT

An optical imaging system includes a first lens group having negative refractive power, a second lens group having positive refractive power, and a third lens group having negative refractive power, wherein the second lens group and the third lens group are configured to move in an optical axis direction to adjust a focal length and magnification, and the following conditional expression is satisfied,

FNOt≤3.6,
where FNOt is an F value at a telephoto end of the optical imaging system.

### CROSS-REFERENCE TO RELATED APPLICATIONS

This application claims the benefit under 35 USC 119(a) of Korean Patent Application No. 10-2022-0137687, filed on Oct. 24, 2022, in the Korean Intellectual Property Office, the entire disclosure of which is incorporated herein by reference for all purposes.

### BACKGROUND

### 1. Field

The present disclosure relates to an optical imaging system capable of adjusting focus magnification.

### 2. Description of the Background

Various types of cameras such as wide cameras, telephoto cameras, and the like may be mounted in portable terminals.

Meanwhile, when imaging a distant object, a telephoto camera may be used. In the case of a telephoto camera employed in a portable terminal, since the telephoto camera may have a fixed zoom magnification, zooming and imaging may be performed through digital zooming, other than the zoom magnification of the telephoto camera, but there may be a problem of image quality deterioration.

In order to solve this problem, an optical zoom lens in which a lens group moves may sometimes be employed in a telephoto camera. However, at a high magnification and a long focal length, a plastic lens may have a problem in resolution, and a glass lens may have a problem in that manufacturing costs may increase.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group having negative refractive power, a second lens group having positive refractive power, and a third lens group having negative refractive power, wherein the second lens group and the third lens group are configured to move in an optical axis direction to adjust a focal length and magnification, and the following conditional expression is satisfied,

FNOt≤3.6,
where FNOt is an F value at a telephoto end of the optical imaging system.

The optical imaging system may further include a stop disposed between the first lens group and the second lens group.

The optical imaging system may further include an optical path convertor disposed on an object side of the first lens group.

The first and second lens groups may each include two or three lenses, wherein a first lens of the second lens group may have positive refractive power.

A first lens of the second lens group may satisfy the following conditional expression, 55<G2L1, where G2L1 is an Abbe number of the first lens of the second lens group.

The following conditional expression may be satisfied, fw/ft<0.7, where fw is a focal length at a wide-angle end of the optical imaging system, and ft is a focal length at a telephoto end of the optical imaging system.

The following conditional expression may be satisfied, dtG12/dwG12<0.3, where dtG12 is a distance between the first lens group and the second lens group at a telephoto end of the optical imaging system, and dwG12 is a distance between the first lens group and the second lens group at a wide-angle end of the optical imaging system.

The following conditional expression may be satisfied, 1.6<FOVw/FOVt, where FOVw is a field of view at a wide-angle end of the optical imaging system, and FOVt is a field of view at a telephoto end of the optical imaging system.

The following conditional expression may be satisfied, |fG2/fG3|<0.6, where fG2 is a total focal length of the second lens group of the optical imaging system, and fG3 is a total focal length of the third lens group of the optical imaging system.

In another general aspect, an optical imaging system includes a first lens, a second lens, a third lens, a fourth lens, a fifth lens, a sixth lens, and a seventh lens sequentially disposed from an object side, forming first, second, and third lens groups sequentially disposed from an object side, wherein at least a portion of the first to seventh lenses are formed of a plastic material, wherein an optical axis distance between the first lens group and the second lens group, and an optical axis distance between the second lens group and the third lens group are configured to vary.

The first lens group may include two or three lenses, and the third lens group may include two lenses.

The lenses included in the second and third lens groups may have a specific gravity of 2 g/cm³.

At least one of the third lens and the fourth lens may have positive refractive power.

The second lens may have refractive power of a sign, opposite to that of at least one of the first lens or the third lens.

The first, second, and third lens groups sequentially may have negative, positive, and negative refractive power.

The following conditional expression may be satisfied, FNOt≤3.6, where FNOt is an F value at a telephoto end of the optical imaging system.

In another general aspect, an optical imaging system includes a first lens, a second lens, a third lens, a fourth lens, a fifth lens, a sixth lens, and a seventh lens sequentially disposed from an object side, forming first, second, and third lens groups sequentially disposed from an object side, and an optical path convertor disposed on an object side of the first lens group, wherein the first lens has a positive refractive power, wherein the second lens group and the third lens group are configured to move in an optical axis direction to adjust a focal length and magnification, and wherein the first lens group is fixed in an optical axis direction.

At least a portion of the first to seventh lenses may be formed of a plastic material.

The lenses included in the second and third lens groups may have a specific gravity of 2 g/cm³ or less.

Other features and aspects will be apparent from the following detailed description, the drawings, and the claims.

### BRIEF DESCRIPTION OF DRAWINGS

FIGS. 1 and 2 are block diagrams of an optical imaging system according to a first embodiment of the present disclosure.

FIGS. 3 and 4 are aberration curves of the optical imaging system illustrated in FIGS. 1 and 2.

FIGS. 5 and 6 are block diagrams of an optical imaging system according to a second embodiment of the present disclosure.

FIGS. 7 and 8 are aberration curves of the optical imaging system illustrated in FIGS. 5 and 6.

FIGS. 9 and 10 are block diagrams of an optical imaging system according to a third embodiment of the present disclosure.

FIGS. 11 and 12 are aberration curves of the optical imaging system illustrated in FIGS. 9 and 10.

FIGS. 13 and 14 are block diagrams of an optical imaging system according to a fourth embodiment of the present disclosure.

FIGS. 15 and 16 are aberration curves of the optical imaging system illustrated in FIGS. 13 and 14.

FIGS. 17 and 18 are block diagrams of an optical imaging system according to a fifth embodiment of the present disclosure.

FIGS. 19 and 20 are aberration curves of the optical imaging system illustrated in FIGS. 17 and 18.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In the drawings, the thicknesses, sizes, and shapes of the lenses may be exaggerated for explanation, and in particular, the shapes of the spherical or aspherical surfaces illustrated in the drawings are only presented as examples, but are not limited thereto.

An aspect of the present disclosure is to provide a zoom-type imaging optical system capable of acquiring a bright image at a long focal length at a telephoto end.

Another aspect of the present disclosure is to provide an optical imaging system applied to a portable terminal having price competitiveness.

An optical imaging system according to an embodiment of the present disclosure may include a plurality of lenses having refractive power disposed on an optical axis. For example, the optical imaging system may include seven lenses. For example, the optical imaging system may include a first lens, a second lens, a third lens, a fourth lens, a fifth lens, a sixth lens, and a seventh lens, sequentially disposed from an object side. For example, the optical imaging system may include no more than seven lenses.

In the present specification, the first lens means a lens closest to an object (or a subject), and the seventh lens means a lens closest to an imaging plane (or an image sensor).

In addition, in the present specification, in each lens, the first surface means a surface (or object-side surface) close to an object side, and the second surface means a surface (or image-side surface) close to an image side.

In the present specification, all units such as a curvature of radius, a thickness, TTL (a distance from an object-side surface of the first lens to an imaging plane), BFL (distance from an image-side surface of the seventh lens to an imaging plane), a focal length (f), IMH (½ of a diagonal length of the imaging plane) are represented in millimeters (mm), and a unit of FOV (angle of view of the optical imaging system) is represented in degrees (°).

In addition, in the present specification, in an explanation of a shape of each lens, a convex shape on one surface may mean that a paraxial region (a very narrow region near and including an optical axis) of the surface is convex, and a concave shape on one surface may mean that a paraxial region of the surface is concave. Therefore, even when one surface of the lens is described as having a convex shape, a paraxial region of the surface is convex, and an edge portion of the lens may be concave. Similarly, even when one surface of the lens is described as having a concave shape a paraxial region of the surface is concave, and an edge portion of the lens may be convex.

The optical imaging system according to an embodiment of the present disclosure may include an optical path convertor for refracting or reflecting incident light and a stop for adjusting an amount of incident light. For example, the optical path convertor may be a prism or a mirror, and may be disposed on an object side. In addition, for example, the stop may be disposed between a second lens and a third lens or between a third lens and a fourth lens.

In addition, the optical imaging system may include an image sensor (or imaging device) for converting an image of a subject, incident through an optical system into an electrical signal, and an infrared cut-off filter for blocking infrared rays. The infrared cut-off filter may be disposed between a seventh lens and an image sensor.

According to an embodiment of the present disclosure, a plurality of lenses may be formed of a material having a refractive index, different from that of air. The optical imaging system according to an embodiment of the present disclosure may include a plastic lens, for example, at least a portion of the first to seventh lenses may be made of a plastic material having a specific gravity of 2 g/cm³ or less.

In addition, at least one of the plurality of lenses may be aspherical. For example, at least one of the first to seventh lenses may have an aspherical surface. Alternatively, at least one of the first and second surfaces of the first to seventh lenses may be aspherical. The aspherical surfaces of the first to seventh lenses are expressed by Equation 1.

$$Z = \frac{c {r}^{2}}{1 + \sqrt{1 - ( 1 + k ) {c}^{2} {r}^{2}}} + A {r}^{4} + B {r}^{6} + C {r}^{8} + D {r}^{10} + E {r}^{12} + F {r}^{14} + G {r}^{16} + H {r}^{18} + J {r}^{20} … \qquad [ Equation 1 ]$$

where c is a reciprocal of a radius of curvature of the lens, k is a conical constant, r is a distance from any point on an aspherical surface to an optical axis, A to H and J are aspherical surface constants, and Z (or SAG) is a distance in an optical axis direction from any point on an aspherical surface to an apex of the aspherical surface.

The optical imaging system according to an embodiment of the present disclosure may be composed of a plurality of lens groups. For example, the optical imaging system may be composed of a first lens group, a second lens group, and a third lens group, sequentially disposed from an object side. For example, the first to third lens groups may include seven lenses.

According to an embodiment of the present disclosure, the first lens group may include a plurality of lenses. For example, the first lens group may include two lenses having refractive power of different signs, and may include a first lens and a second lens. For example, the first lens group may have negative refractive power as a whole.

According to an embodiment of the present disclosure, the second lens group may include a plurality of lenses. For example, the second lens group may include three lenses, and may include a third lens, a fourth lens, and a fifth lens. For example, the second lens group may have positive refractive power as a whole.

According to an embodiment of the present disclosure, the third lens group may include a plurality of lenses. For example, the third lens group may include two lenses, and may include a sixth lens and a seventh lens. For example, the third lens group may have negative refractive power as a whole.

According to an embodiment of the present disclosure, at least one of the first to third lens groups may move in an optical axis direction. For example, the second lens group and the third lens group may be moved in the optical axis direction to change a focal length and magnification of the optical imaging system. For example, the second lens group and the third lens group may be simultaneously moved in the optical axis direction. The second lens group and the third lens group may move in an imaging plane direction in the optical axis direction to enable short-distance imaging of the optical imaging system (wide-angle imaging). In addition, the second lens group and the third lens group may move in a direction of the first lens group in the optical axis direction to enable long-distance imaging of the optical imaging system (telephoto imaging). Meanwhile, in the first lens group, a distance to the imaging plane may be maintained to be constant regardless of focal length and magnification adjustment.

According to an embodiment of the present disclosure, the optical imaging system may include a prism, and the prism may be disposed on an object side of the first lens group.

The optical imaging system according to an embodiment of the present disclosure may satisfy at least one of the following Conditional Expressions 1 to 6.

fw/ft<0.7 [Conditional Expression 1]

55<G2L1 [Conditional Expression 2]

dtG12/dwG12<0.3 [Conditional Expression 3]

1.6<FOVw/FOVt [Conditional Expression 4]

|fG2/fG3|<0.6 [Conditional Expression 5]

FNOt≤3.6 [Conditional Expression 6]

In the above conditional expressions, fw is a focal length at a wide-angle end of the optical imaging system, ft is a focal length at a telephoto end of the optical imaging system, G2L1 is Abbe number of a first lens of the second lens group, dtG12 is a distance between the first lens group and the second lens group at a telephoto end of the optical imaging system, dwG12 is a distance between the first lens group and the second lens group at a wide-angle end of the optical imaging system, FOVw is an angle of a field of view at a wide-angle end of the optical imaging system, FOVt is an angle of a field of view at a telephoto end of the optical imaging system, fG2 is a total focal length of the second lens group of the optical imaging system, fG3 is a total focal length of the third lens group of the optical imaging system, and FNOt is an F value at a telephoto end of the optical imaging system.

Hereinafter, various embodiments of an optical imaging system of the present disclosure will be described.

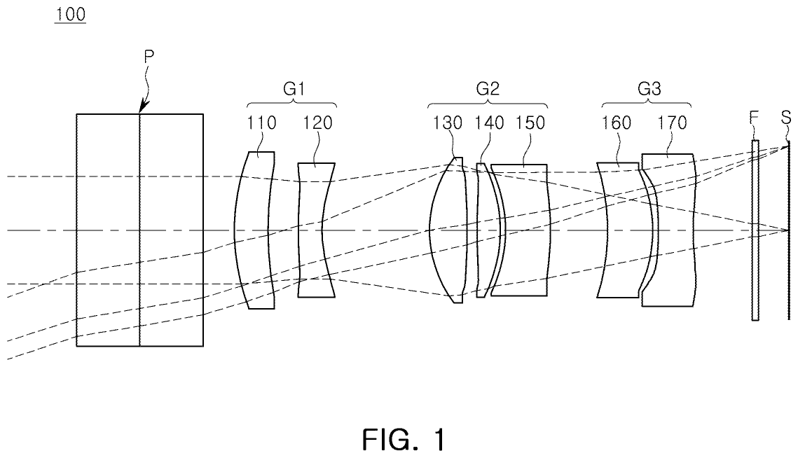

First, an optical imaging system according to a first embodiment of the present disclosure will be described with reference to FIGS. 1 to 4.

An optical imaging system 100 according to a first embodiment of the present disclosure may include a first lens group G1, a second lens group G2, and a third lens group G3. The optical imaging system 100 may include a first lens 110, a second lens 120, a third lens 130, a fourth lens 140, a fifth lens 150, a sixth lens 160, and a seventh lens 170, sequentially disposed from an object side.

The first lens group G1 may include two lenses. For example, the first lens group G1 may include the first lens 110 and the second lens 120. The first lens 110 and the second lens 120 may have refractive power of different signs. For example, the first lens 110 may have positive refractive power and the second lens 120 may have negative refractive power. In addition, the first lens 110 and the second lens 120 may each have a convex object-side surface and a concave image-side surface. The first lens group G1 may have negative refractive power as a whole.

The second lens group G2 may include three lenses. For example, the second lens group G2 may include the third lens 130, the fourth lens 140, and the fifth lens 150. The third lens 130 may have positive refractive power, and may have a convex object-side surface and a convex image-side surface. The fourth lens 140 may have positive refractive power, and may have a convex object-side surface and a convex image-side surface. The fifth lens 150 may have negative refractive power, and may have a concave object-side surface and a convex image-side surface. The second lens group G2 may have positive refractive power as a whole.

The third lens group G3 may include two lenses. For example, the third lens group G3 may include the sixth lens 160 and the seventh lens 170. The sixth lens 160 and the seventh lens 170 may have refractive power of different signs. For example, the sixth lens 160 may have positive refractive power, and the seventh lens 170 may have negative refractive power. In addition, the sixth lens 160 may have a concave object-side surface and a convex image-side surface, and the seventh lens 170 may have a concave object-side surface and a concave image-side surface. The third lens group G3 may have negative refractive power as a whole.

The first to seventh lenses 110 to 170 may include lenses formed of a plastic material, and in particular, lenses constituting the second lens group G2 and the third lens group G3 among the first to seventh lenses 110 to 170 may be formed of a plastic material having a specific gravity of 2 g/cm³ or less. For example, the third to seventh lenses 130 to 170 may be formed of a plastic material having a specific gravity of 2 g/cm³ or less.

The second lens group G2 and the third lens group G3 may move in an optical axis direction to change a focal length and magnification of the optical imaging system 100. An optical axis distance between the first lens group G1 and the second lens group G2 and an optical axis distance between the second lens group G2 and the third lens group G3 may be inversely proportional to focal magnification of the optical imaging system 100. For example, the optical axis distance between the first lens group G1 and the second lens group G2 and the optical axis distance between the second lens group G2 and the third lens group G3 may be longer as the focal magnification of the optical imaging system 100 decreases, and may be shorter as the focal magnification of the optical imaging system 100 increases.

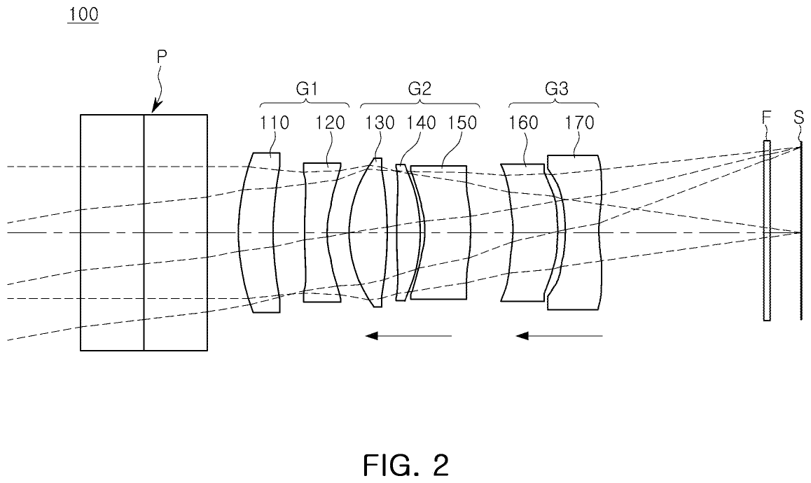

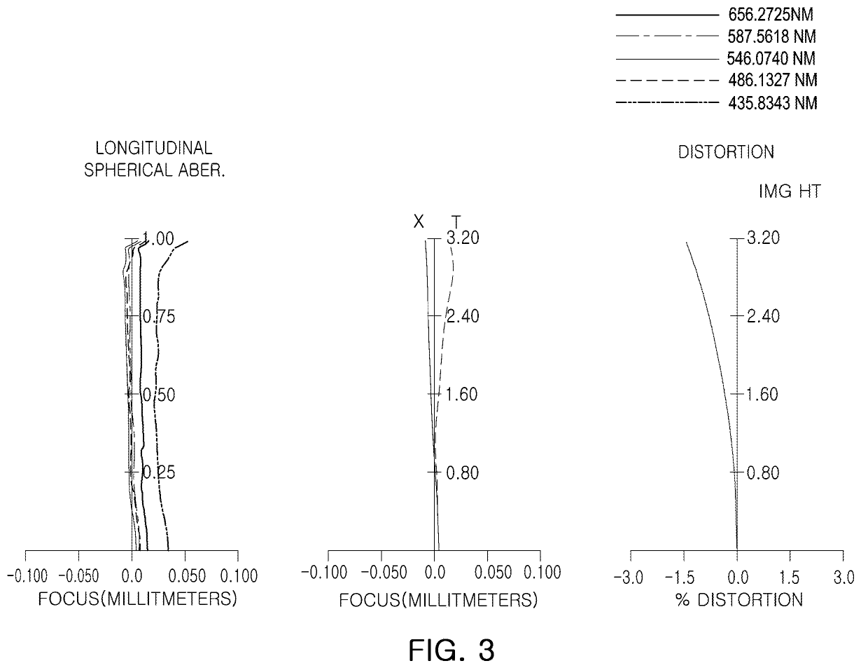

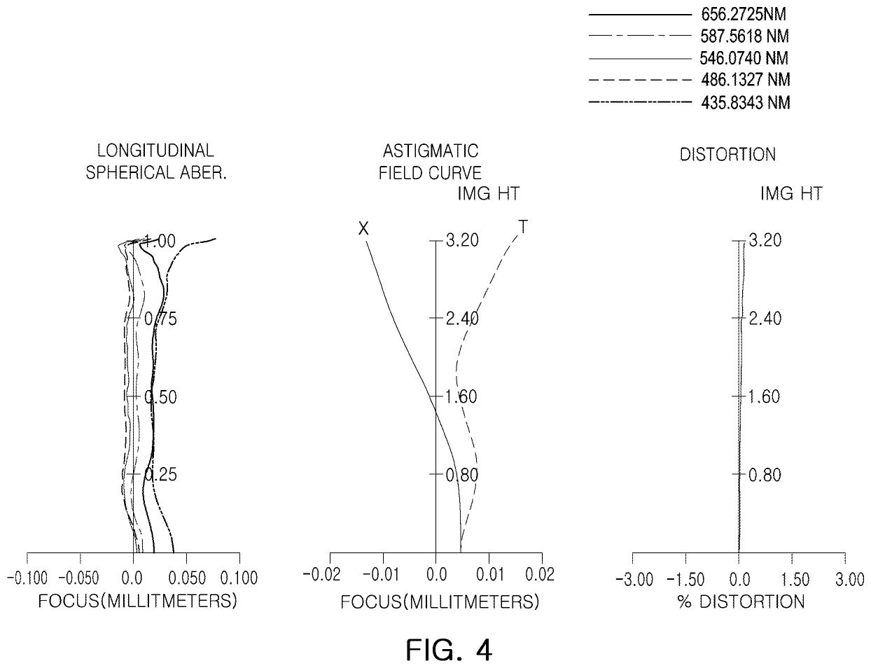

FIGS. 1 and 2 illustrate an optical imaging system at a wide-angle end and a telephoto end, respectively, and FIGS. 3 and 4 illustrate aberration characteristics of the optical imaging system according to the wide-angle end and the telephoto end, respectively.

The optical imaging system 100 according to a first embodiment of the present disclosure may further include a prism P, a stop, an infrared cut-off filter F, and an image sensor S.

The prism P may be disposed on an object side of the first lens 110. The prism P may refract or reflect a path of light incident to the optical imaging system 100. The stop may adjust an amount of light, and may be disposed between the first lens group G1 and the second lens group G2, for example, between the second lens 120 and the third lens 130. The filter F may be disposed in front of the image sensor S to block infrared rays included in the light from being incident to the optical imaging system 100. The image sensor S may include an imaging plane, and light passing through the first lens 110 to the seventh lens 170 may be incident on the imaging plane.

Table 1 below is a table illustrating lens characteristics of the optical imaging system according to a first embodiment of the present disclosure, and Table 2 below is a table illustrating aspherical surface values of the optical imaging system according to a first embodiment of the present disclosure.

TABLE 1

| | | | Thickness/ | Thickness/ | | |
|---|---|---|---|---|---|---|
| Surface | | Radius of | distance | distance | Refractive | Abbe |
| No. | Reference | curvature | (Wide-angle end) | (Telephoto end) | index | number |
| 1 | Prism | Infinity | 2.400 | 2.400 | 1.717 | 29.5 |
| 2 | | Infinity | 2.400 | 2.400 | 1.717 | 29.5 |
| 3 | | Infinity | 1.200 | 1.200 | | |
| 4 | First lens | 13.281 | 1.245 | 1.245 | 1.661 | 20.4 |
| 5 | | 25.571 | 1.175 | 1.175 | | |
| 6 | Second lens | 10.274 | 0.857 | 0.857 | 1.544 | 56 |
| 7 | | 3.455 | 4.098 | 0.800 | | |
| 8(stop) | Third lens | 4.332 | 1.451 | 1.451 | 1.544 | 56 |
| 9 | | −23.630 | 0.362 | 0.362 | | |
| 10 | Fourth lens | 13.391 | 0.889 | 0.889 | 1.535 | 55.7 |
| 11 | | −5.823 | 0.195 | 0.195 | | |
| 12 | Fifth lens | −3.605 | 1.688 | 1.688 | 1.661 | 20.4 |
| 13 | | −8.160 | 2.193 | 1.606 | | |
| 14 | Sixth lens | −5.162 | 1.710 | 1.710 | 1.661 | 20.4 |
| 15 | | −4.549 | 0.214 | 0.214 | | |
| 16 | Seventh lens | −32.476 | 1.282 | 1.282 | 1.544 | 56 |
| 17 | | 6.301 | 2.257 | 6.148 | | |
| 18 | Filter | Infinity | 0.210 | 0.210 | 1.517 | 64.2 |
| 19 | | Infinity | 1.178 | 1.178 | | |
| 20 | Imaging plane | Infinity | −0.005 | −0.005 | | |

TABLE 2

| Surface | | | | | | | |
|---|---|---|---|---|---|---|---|
| No. | 4 | 5 | 6 | 7 | 8 | 9 | 10 |
| K | −21.776204 | −43.574643 | 10.9711648 | −5.7067711 | −0.2327510 | 68.806678 | −89.695447 |
| A | 2.914E−03 | 2.211E−03 | −1.779E−02 | −5.548E−03 | 6.722E−05 | −9.053E−04 | 1.424E−03 |
| B | 6.477E−05 | 3.407E−04 | 1.712E−03 | 8.326E−05 | 8.465E−05 | 2.357E−03 | 7.942E−04 |
| C | −7.304E−05 | −2.199E−04 | −4.423E−05 | 2.987E−04 | 2.442E−04 | −1.613E−03 | −1.580E−03 |
| D | 3.865E−05 | 1.372E−04 | −1.565E−05 | −9.399E−05 | −2.612E−04 | 3.075E−04 | −2.232E−05 |
| E | −1.141E−05 | −5.162E−05 | −5.604E−06 | 9.625E−06 | 1.149E−04 | 6.401E−05 | 3.095E−04 |
| F | 2.087E−06 | 1.215E−05 | 3.851E−06 | 1.901E−06 | −2.810E−05 | −4.143E−05 | −1.240E−04 |
| G | −2.303E−07 | −1.724E−06 | −8.491E−07 | −7.309E−07 | 3.979E−06 | 8.293E−06 | 2.371E−05 |
| H | 1.402E−08 | 1.353E−07 | 8.782E−08 | 8.954E−08 | −3.069E−07 | −7.814E−07 | −2.303E−06 |
| J | −3.608E−10 | −4.485E−09 | −3.590E−09 | −4.009E−09 | 1.003E−08 | 2.935E−08 | 9.058E−08 |

| | 11 | 12 | 13 | 14 | 15 | 16 | 17 |
|---|---|---|---|---|---|---|---|
| K | −1.4755453 | −5.0629748 | −17.394785 | 3.67691424 | 2.23146486 | 51.5665997 | 3.12958309 |
| A | 7.302E−03 | 2.952E−03 | 3.405E−03 | 1.342E−02 | −1.385E−04 | −3.465E−02 | −2.703E−02 |
| B | −2.713E−03 | −2.219E−03 | −2.428E−04 | −1.859E−03 | 4.725E−03 | 9.249E−03 | 4.928E−03 |
| C | 9.344E−05 | 1.210E−03 | 3.447E−04 | 1.914E−03 | −1.313E−03 | −2.636E−03 | −1.091E−03 |
| D | 5.652E−05 | −2.200E−04 | −1.062E−04 | −1.376E−03 | −4.876E−05 | 3.058E−04 | 1.887E−04 |
| E | 2.192E−05 | −5.320E−05 | −9.716E−06 | 6.792E−04 | 1.905E−04 | 7.105E−05 | −2.239E−05 |
| F | −2.214E−05 | 3.276E−05 | 1.507E−05 | −2.122E−04 | −7.092E−05 | −3.271E−05 | 1.541E−06 |
| G | 6.687E−06 | −6.160E−06 | −4.237E−06 | 4.107E−05 | 1.361E−05 | 5.238E−06 | −5.429E−08 |
| H | −8.969E−07 | 5.070E−07 | 5.383E−07 | −4.490E−06 | −1.415E−06 | −4.161E−07 | 1.345E−09 |
| J | 4.475E−08 | −1.524E−08 | −2.695E−08 | 2.141E−07 | 6.454E−08 | 1.507E−08 | −7.100E−11 |

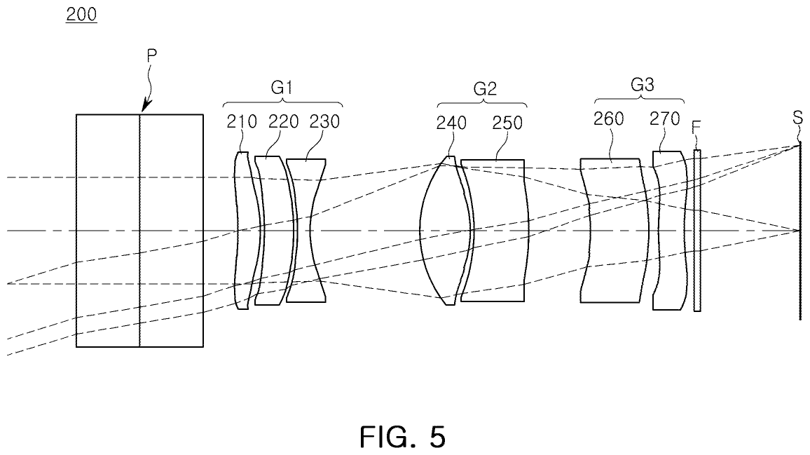

Next, an optical imaging system according to a second embodiment of the present disclosure will be described with reference to FIGS. 5 to 8.

An optical imaging system 200 according to a second embodiment of the present disclosure may include a first lens group G1, a second lens group G2, and a third lens group G3. The optical imaging system 200 may include a first lens 210, a second lens 220, a third lens 230, a fourth lens 240, a fifth lens 250, a sixth lens 260, and a seventh lens 270, sequentially disposed from an object side.

The first lens group G1 may include three lenses. For example, the first lens group G1 may include the first lens 210, the second lens 220, and the third lens 230. The first lens 210 and the second lens 220 may each have positive refractive power, and the third lens 230 may have negative refractive power. In addition, the first lens 210 and the second lens 220 may each have a concave object-side surface and a convex image-side surface, and the third lens 230 may have a concave object-side surface and a concave image-side surface. The first lens group G1 may have negative refractive power as a whole.

The second lens group G2 may include two lenses. For example, the second lens group G2 may include the fourth lens 240 and the fifth lens 250. The fourth lens 240 may have positive refractive power, and may have a convex object-side surface and a convex image-side surface. The fifth lens 250 may have negative refractive power, and may have a concave object-side surface and a convex image-side surface. The second lens group G2 may have positive refractive power as a whole.

The third lens group G3 may include two lenses. For example, the third lens group G3 may include the sixth lens 260 and the seventh lens 270. The sixth lens 260 and the seventh lens 270 may each have negative refractive power. In addition, the sixth lens 260 may have a concave object-side surface and a convex image-side surface, and the seventh lens 270 may have a convex object-side surface and a concave image-side surface. The third lens group G3 may have negative refractive power as a whole.

The first to seventh lenses 210 to 270 may include lenses formed of a plastic material, and in particular, lenses constituting the second lens group G2 and the third lens group G3 among the first to seventh lenses 210 to 270 may be formed of a plastic material having a specific gravity of 2 g/cm³ or less. For example, the fourth to seventh lenses 240 to 270 may be formed of a plastic material having a specific gravity of 2 g/cm³ or less.

The second lens group G2 and the third lens group G3 may move in an optical axis direction to change a focal length and magnification of the optical imaging system 200. An optical axis distance between the first lens group G1 and the second lens group G2 and an optical axis distance between the second lens group G2 and the third lens group G3 may be inversely proportional to focal magnification of the optical imaging system 200. For example, the optical axis distance between the first lens group G1 and the second lens group G2 and the optical axis distance between the second lens group G2 and the third lens group G3 may be longer as the focal magnification of the optical imaging system 200 decreases, and may be shorter as the focal magnification of the optical imaging system 200 increases.

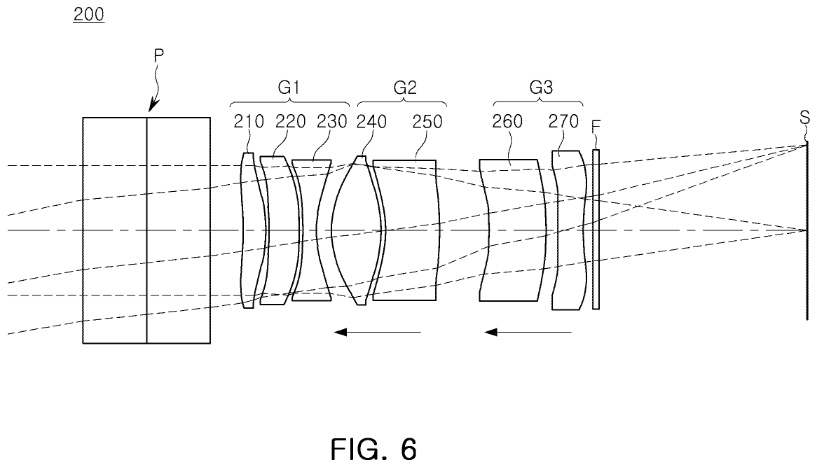

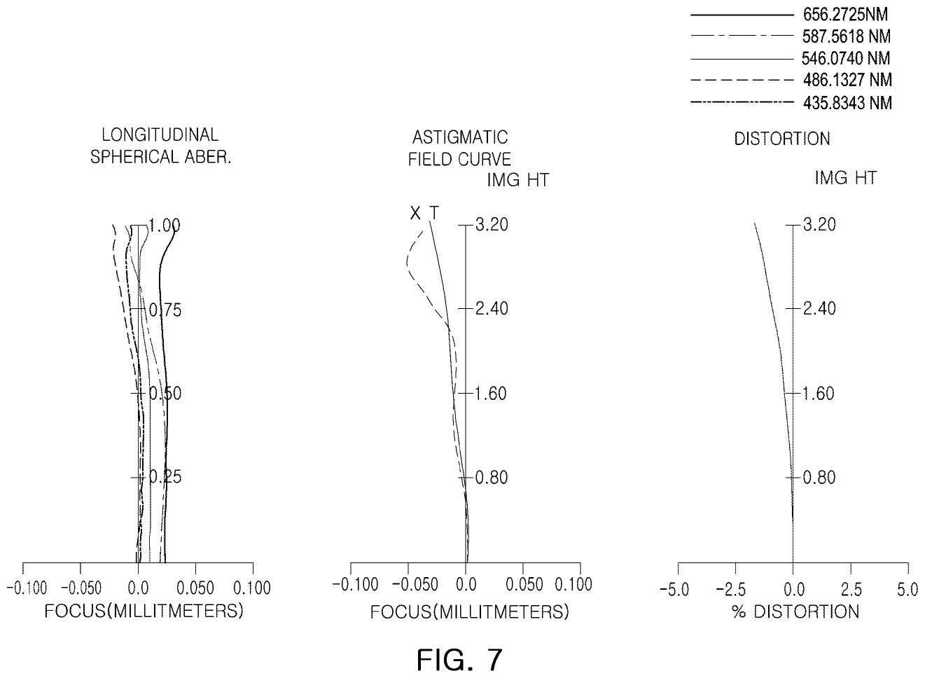

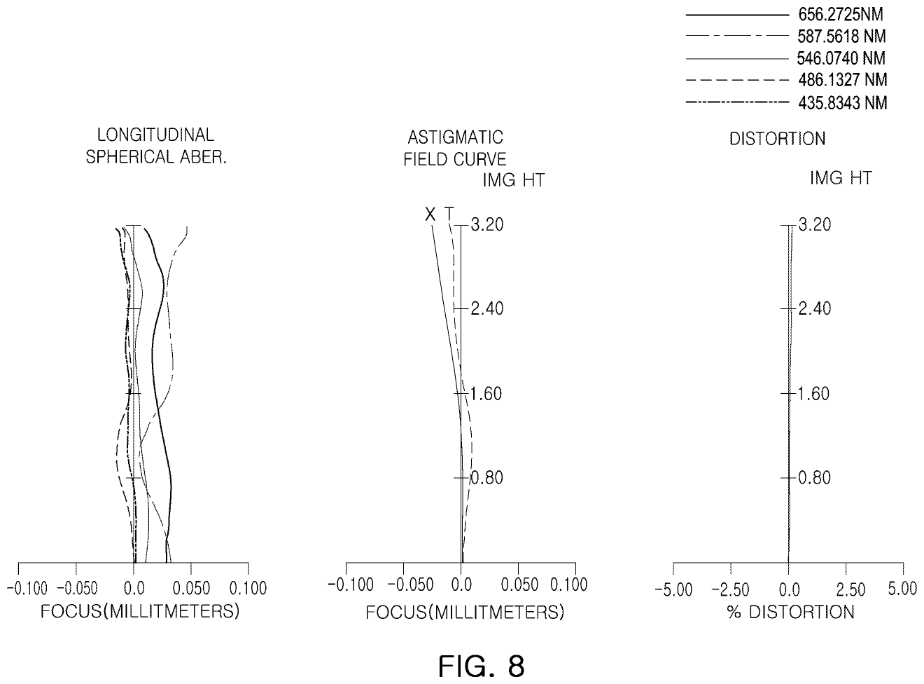

FIGS. 5 and 6 illustrate an optical imaging system at a wide-angle end and a telephoto end, respectively, and FIGS. 7 and 8 illustrate aberration characteristics of the optical imaging system according to the wide-angle end and the telephoto end, respectively.

The optical imaging system 200 according to a second embodiment of the present disclosure may further include a prism P, a stop, an infrared cut-off filter F, and an image sensor S.

The prism P may be disposed on an object side of the first lens 210. The prism P may refract or reflect a path of light incident to the optical imaging system 200. The stop may adjust an amount of light, and may be disposed between the first lens group G1 and the second lens group G2, for example, between the third lens 230 and the fourth lens 240. The filter F may be disposed in front of the image sensor S to block infrared rays included in the light incident to the optical imaging system 200. The image sensor S may include an imaging plane, and light passing through the first lens 210 to the seventh lens 270 may be incident on the imaging plane.

Table 3 below is a table illustrating lens characteristics of the optical imaging system according to a second embodiment of the present disclosure, and Table 4 below is a table illustrating aspherical surface values of the optical imaging system according to a second embodiment of the present disclosure.

TABLE 3

| | | | Thickness/ | Thickness/ | | |
|---|---|---|---|---|---|---|
| Surface | | Radius of | distance | distance | Refractive | Abbe |
| No. | Reference | curvature | (Wide-angle end) | (Telephoto end) | index | number |
| 1 | Prism | Infinity | 2.400 | 2.400 | 1.717 | 29.5 |
| 2 | | Infinity | 2.400 | 2.400 | 1.717 | 29.5 |
| 3 | | Infinity | 1.200 | 1.200 | | |
| 4 | First lens | −12.118 | 0.874 | 0.874 | 1.544 | 56 |
| 5 | | −3.910 | 0.100 | 0.100 | | |
| 6 | Second lens | −20.793 | 1.140 | 1.140 | 1.661 | 20.4 |
| 7 | | −9.858 | 0.132 | 0.132 | | |
| 8 | Third lens | −12.051 | 0.450 | 0.450 | 1.544 | 56 |
| 9 | | 3.245 | 4.099 | 0.580 | | |
| 10(stop) | Fourth lens | 4.113 | 1.886 | 1.886 | 1.544 | 56 |
| 11 | | −4.202 | 0.160 | 0.160 | | |
| 12 | Fifth lens | −4.289 | 2.000 | 2.000 | 1.661 | 20.4 |
| 13 | | −9.268 | 2.336 | 1.853 | | |
| 14 | Sixth lens | −4.844 | 2.150 | 2.150 | 1.544 | 56 |
| 15 | | −6.484 | 0.377 | 0.377 | | |
| 16 | Seventh lens | 8.329 | 0.900 | 0.900 | 1.535 | 55.7 |
| 17 | | 4.688 | 0.403 | 0.403 | | |
| 18 | Filter | Infinity | 0.210 | 0.210 | 1.517 | 64.2 |
| 19 | | Infinity | 3.786 | 7.787 | | |
| 20 | Imaging plane | Infinity | −0.005 | −0.005 | | |

TABLE 4

| Surface No. | 4 | 5 | 6 | 7 | 8 | 9 | 10 |
|---|---|---|---|---|---|---|---|
| K | 11.128521 | −1.3119788 | 52.605861 | 5.0313107 | 8.8628933 | −0.4868815 | −0.1215885 |
| A | 6.668E−03 | 1.686E−02 | −3.119E−03 | −9.695E−03 | −1.011E−02 | −2.211E−02 | −9.925E−04 |
| B | −3.453E−04 | −2.400E−03 | 1.372E−03 | 6.748E−03 | 6.208E−03 | 3.236E−03 | −3.544E−05 |
| C | 6.716E−05 | 3.403E−04 | −2.907E−04 | −2.287E−03 | −2.301E−03 | −5.047E−04 | 9.769E−05 |
| D | −4.147E−07 | −4.476E−05 | −1.448E−05 | 3.808E−04 | 4.448E−04 | 6.889E−05 | −3.608E−05 |
| E | −1.416E−06 | 2.676E−06 | 6.874E−06 | −3.191E−05 | −4.387E−05 | −6.757E−06 | 5.523E−06 |
| F | 1.301E−07 | 1.014E−08 | −3.592E−07 | 1.093E−06 | 1.755E−06 | 3.056E−07 | −3.179E−07 |
| G | 0.000E+00 | 0.000E+00 | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 | 0.000E+00 |

| | 11 | 12 | 13 | 14 | 15 | 16 | 17 |
|---|---|---|---|---|---|---|---|
| K | −0.0867356 | −0.5909439 | −6.8451162 | −8.9108616 | −23.713702 | 5.62244406 | 0.16472732 |
| A | −1.422E−03 | −2.431E−03 | 1.358E−03 | 0.00159031 | −0.0074313 | −0.0291810 | −0.0300927 |
| B | 5.910E−03 | 6.514E−03 | 1.024E−03 | 0.00021763 | 0.00412616 | 0.00474014 | 0.00491934 |
| C | −1.914E−03 | −2.349E−03 | −3.614E−04 | −0.0003029 | −0.0017597 | −0.0016917 | −0.0010993 |
| D | 3.356E−04 | 4.807E−04 | 9.024E−05 | 0.00014317 | 0.00054518 | 0.00054759 | 0.00023793 |
| E | −3.002E−05 | −5.408E−05 | −1.140E−05 | −3.08E−05 | −9.81E−05 | −0.0001037 | −3.68E−05 |
| F | 1.052E−06 | 2.934E−06 | 6.222E−07 | 3.04E−06 | 8.90E−06 | 9.43E−06 | 3.11E−06 |
| G | 0.000E+00 | −5.030E−08 | −1.548E−09 | −1.04E−07 | −3.12E−07 | −3.24E−07 | −1.07E−07 |
| H | 0.000E+00 | −5.030E−08 | −1.548E−09 | −1.04E−07 | −3.12E−07 | −3.24E−07 | −1.07E−07 |
| J | 0.000E+00 | −5.030E−08 | −1.548E−09 | −1.04E−07 | −3.12E−07 | −3.24E−07 | −1.07E−07 |

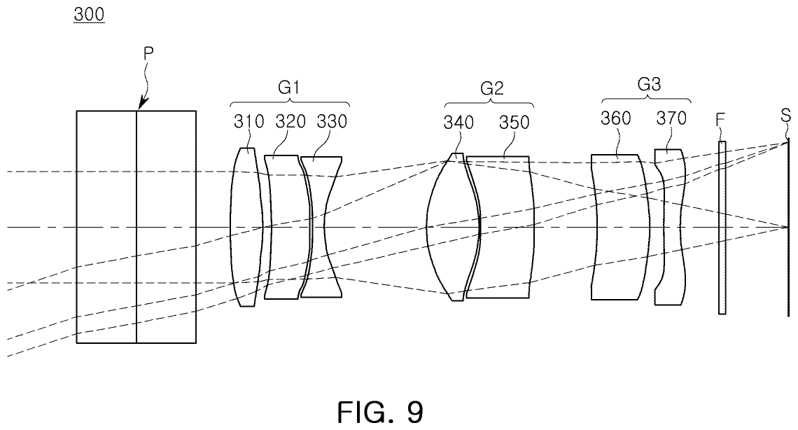

Next, an optical imaging system according to a third embodiment of the present disclosure will be described with reference to FIGS. 9 to 12.

An optical imaging system 300 according to a third embodiment of the present disclosure may include a first lens group G1, a second lens group G2, and a third lens group G3. The optical imaging system 300 may include a first lens 310, a second lens 320, a third lens 330, a fourth lens 340, a fifth lens 350, a sixth lens 360, and a seventh lens 370, sequentially disposed from an object side.

The first lens group G1 may include three lenses. For example, the first lens group G1 may include the first lens 310, the second lens 320, and the third lens 330. The first lens 310 and the second lens 320 may each have positive refractive power, and the third lens 330 may have negative refractive power. In addition, the first lens 310 may have a convex object-side surface and a convex image-side surface, the second lens 320 may have a concave object-side surface and a convex image-side surface, and the third lens 330 may have a concave object-side surface and a concave image-side surface. The first lens group G1 may have negative refractive power as a whole.

The second lens group G2 may include two lenses. For example, the second lens group G2 may include the fourth lens 340 and the fifth lens 350. The fourth lens 340 may have positive refractive power, and may have a convex object-side surface and a convex image-side surface. The fifth lens 350 may have negative refractive power, and may have a concave object-side surface and a convex image-side surface. The second lens group G2 may have positive refractive power as a whole.

The third lens group G3 may include two lenses. For example, the third lens group G3 may include the sixth lens 360 and the seventh lens 370. The sixth lens 360 may have positive refractive power, and the seventh lens 370 may have negative refractive power. In addition, the sixth lens 360 may have a concave object-side surface and a convex image-side surface, and the seventh lens 370 may have a convex object-side surface and a concave image-side surface. The third lens group G3 may have negative refractive power as a whole.

The first to seventh lenses 310 to 370 may include lenses formed of a plastic material, and in particular, lenses constituting the second lens group G2 and the third lens group G3 among the first to seventh lenses 310 to 370 may be formed of a plastic material having a specific gravity of 2 g/cm³ or less. For example, the fourth to seventh lenses 340 to 370 may be formed of a plastic material having a specific gravity of 2 g/cm³ or less.

The second lens group G2 and the third lens group G3 may move in an optical axis direction to change a focal length and magnification of the optical imaging system 300. An optical axis distance between the first lens group G1 and the second lens group G2 and an optical axis distance between the second lens group G2 and the third lens group G3 may be inversely proportional to focal magnification of the optical imaging system 300. For example, the optical axis distance between the first lens group G1 and the second lens group G2 and the optical axis distance between the second lens group G2 and the third lens group G3 may be longer as the focal magnification of the optical imaging system 300 decreases, and may be shorter as the focal magnification of the optical imaging system 300 increases.

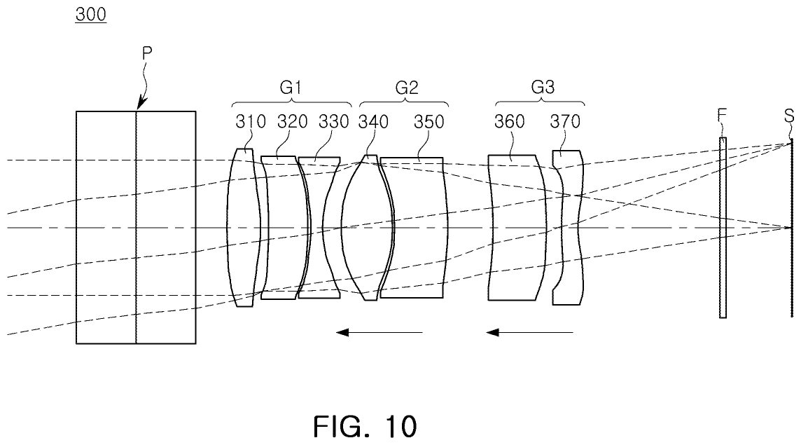

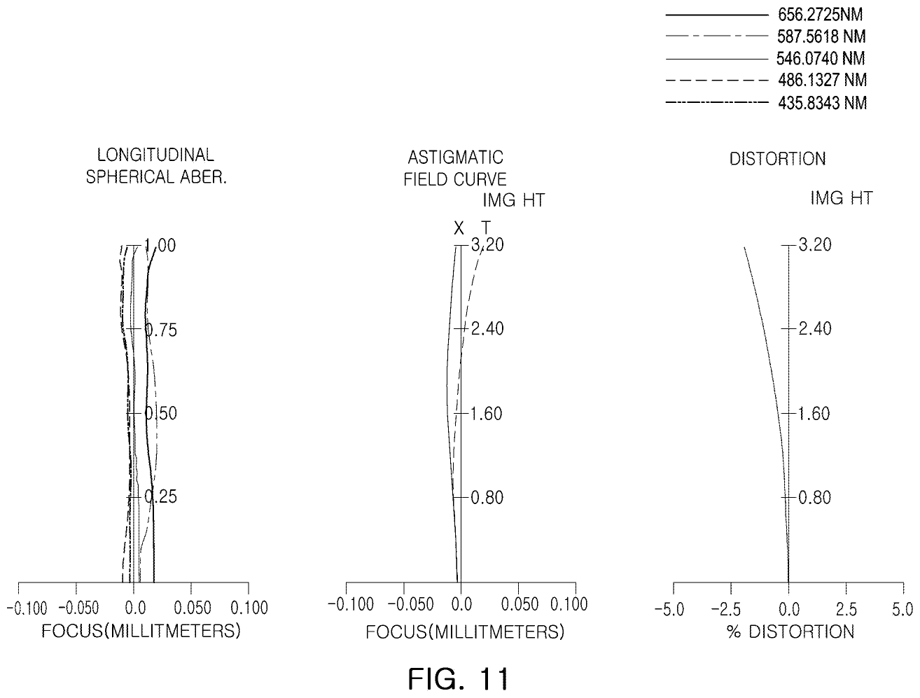

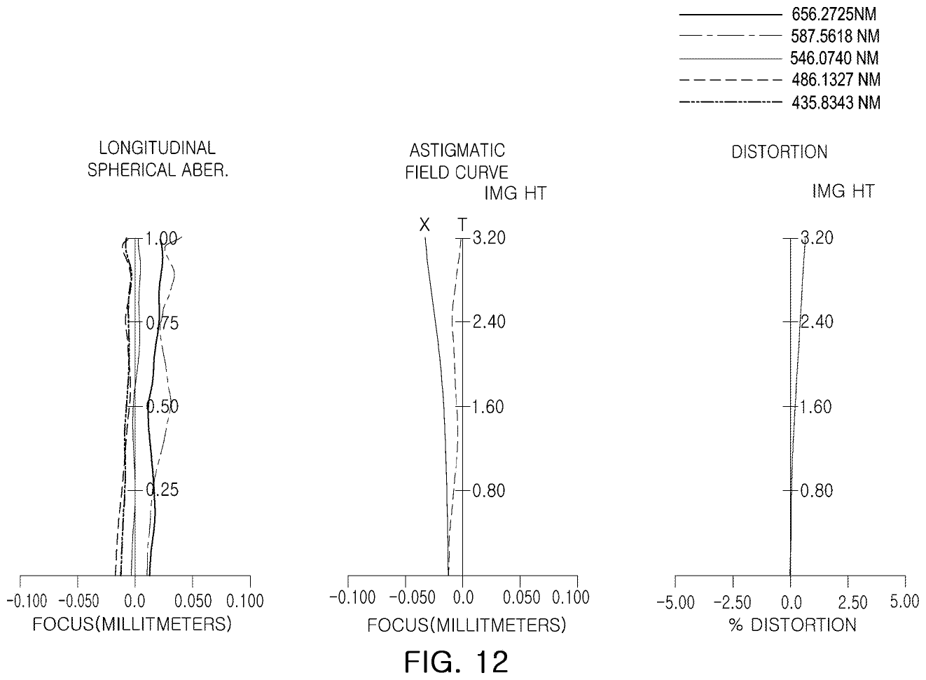

FIGS. 9 and 10 illustrate an optical imaging system at a wide-angle end and a telephoto end, respectively, and FIGS. 11 and 12 illustrate aberration characteristics of the optical imaging system according to the wide-angle end and the telephoto end, respectively.

The optical imaging system 300 according to a third embodiment of the present disclosure may further include a prism P, a stop, an infrared cut-off filter F, and an image sensor S.

The prism P may be disposed on an object side of the first lens 310. The prism P may refract or reflect a path of light incident to the optical imaging system 300. The stop may adjust an amount of light, and may be disposed between the first lens group G1 and the second lens group G2, for example, between the third lens 330 and the fourth lens 340. The filter F may be disposed in front of the image sensor S to block infrared rays included in the light incident to the optical imaging system 300. The image sensor S may include an imaging plane, and light passing through the first lens 310 to the seventh lens 370 may be incident on the imaging plane.

Table 5 below is a table illustrating lens characteristics of the optical imaging system according to a third embodiment of the present disclosure, and Table 6 below is a table illustrating aspherical surface values of the optical imaging system according to a third embodiment of the present disclosure.

TABLE 5

| | | | Thickness/ | Thickness/ | | |
|---|---|---|---|---|---|---|
| Surface | | Radius of | distance | distance | Refractive | Abbe |
| No. | Reference | curvature | (Wide-angle end) | (Telephoto end) | index | number |
| 1 | Prism | Infinity | 2.400 | 2.400 | 1.717 | 29.5 |
| 2 | | Infinity | 2.400 | 2.400 | 1.717 | 29.5 |
| 3 | | Infinity | 1.200 | 1.200 | | |
| 4 | First lens | 52.051 | 1.251 | 1.251 | 1.544 | 56 |
| 5 | | −5.463 | 0.271 | 0.271 | | |
| 6 | Second lens | −17.769 | 1.488 | 1.488 | 1.661 | 20.4 |
| 7 | | −8.859 | 0.109 | 0.109 | | |
| 8 | Third lens | −7.305 | 0.400 | 0.400 | 1.544 | 56 |
| 9 | | 3.303 | 3.861 | 0.650 | | |
| 10(stop) | Fourth lens | 4.268 | 2.000 | 2.000 | 1.544 | 56 |
| 11 | | −4.038 | 0.080 | 0.080 | | |
| 12 | Fifth lens | −4.264 | 2.000 | 2.000 | 1.661 | 20.4 |
| 13 | | −8.804 | 2.298 | 1.648 | | |
| 14 | Sixth lens | −9.604 | 2.000 | 2.000 | 1.544 | 56 |
| 15 | | −10.263 | 0.555 | 0.555 | | |
| 16 | Seventh lens | 5.335 | 0.590 | 0.590 | 1.535 | 55.7 |
| 17 | | 3.134 | 1.513 | 5.363 | | |
| 18 | Filter | Infinity | 0.210 | 0.210 | 1.517 | 64.2 |
| 19 | | Infinity | 2.369 | 2.370 | | |
| 20 | Imaging plane | Infinity | 0.003 | 0.013 | | |

TABLE 6

| Surface | | | | | | | |
|---|---|---|---|---|---|---|---|
| No. | 4 | 5 | 6 | 7 | 8 | 9 | 10 |
| K | 0.000 | −0.7665253 | 3.41014790 | 1.5254121 | −0.1340650 | −0.3311941 | −0.0226955 |
| A | 2.682E−03 | 1.323E−02 | 1.694E−03 | −1.938E−03 | 1.843E−04 | −1.288E−02 | −5.096E−04 |
| B | 9.143E−05 | −1.638E−03 | −4.225E−04 | 3.203E−03 | 1.644E−03 | −3.001E−04 | 2.805E−05 |
| C | −4.048E−06 | 2.089E−04 | −5.265E−05 | −1.712E−03 | −1.356E−03 | 4.344E−04 | 2.661E−05 |
| D | 1.455E−06 | −1.995E−05 | 1.124E−05 | 4.107E−04 | 4.036E−04 | −8.762E−05 | −1.070E−05 |
| E | −1.821E−07 | 5.624E−07 | −2.133E−06 | −4.913E−05 | −5.484E−05 | 7.414E−06 | 1.780E−06 |
| F | 7.613E−09 | 2.015E−08 | 1.690E−07 | 2.328E−06 | 2.796E−06 | −2.332E−07 | −1.052E−07 |
| G | 0.000E+00 | 0.000E+00 | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 | 0.000E+00 |

| | 11 | 12 | 13 | 14 | 15 | 16 | 17 |
|---|---|---|---|---|---|---|---|
| K | −0.0698206 | −0.1929631 | −2.3109391 | −4.2844785 | 9.84816965 | −1.6024037 | −0.0897060 |
| A | −3.161E−03 | −4.969E−03 | 7.684E−04 | 6.199E−03 | 2.140E−03 | −4.386E−02 | −5.121E−02 |
| B | 6.035E−03 | 5.761E−03 | 3.520E−04 | −1.418E−03 | −1.145E−04 | 4.979E−03 | 8.313E−03 |
| C | −1.849E−03 | −1.785E−03 | −2.294E−05 | 3.588E−04 | 1.153E−05 | −1.289E−04 | −1.139E−03 |
| D | 3.273E−04 | 3.370E−04 | 2.026E−06 | −6.438E−05 | 6.594E−06 | −9.791E−05 | 6.915E−05 |
| E | −3.006E−05 | −3.455E−05 | 1.186E−06 | 6.947E−06 | −5.770E−06 | 9.472E−06 | 2.355E−06 |
| F | 1.113E−06 | 1.596E−06 | −2.676E−07 | −3.984E−07 | 9.548E−07 | 4.584E−07 | −5.667E−07 |
| G | 0.000E+00 | −1.528E−08 | 1.971E−08 | 1.025E−08 | −4.539E−08 | −5.424E−08 | 2.197E−08 |
| H | 0.000E+00 | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 | 0.000E+00 |

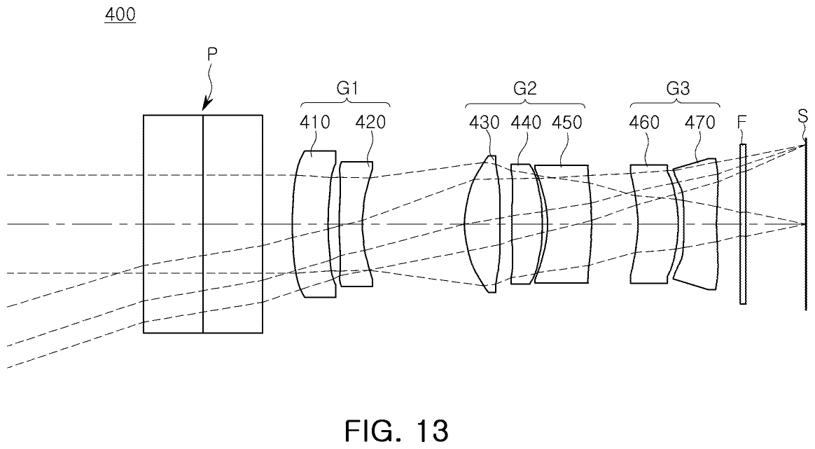

Next, an optical imaging system according to a fourth embodiment of the present disclosure will be described with reference to FIGS. 13 to 16.

An optical imaging system 400 according to a fourth embodiment of the present disclosure may include a first lens group G1, a second lens group G2, and a third lens group G3. The optical imaging system 400 may include a first lens 410, a second lens 420, a third lens 430, a fourth lens 440, a fifth lens 450, a sixth lens 460, and a seventh lens 470, sequentially disposed from an object side.

The first lens group G1 may include two lenses. For example, the first lens group G1 may include the first lens 410, and the second lens 420. The first lens 410 and the second lens 420 may have refractive power of different signs. For example, the first lens 410 may have positive refractive power, and the second lens 420 may have negative refractive power. In addition, both the first lens 410 and the second lens 420 may have a convex object-side surface and a concave image-side surface. The first lens group G1 may have negative refractive power as a whole.

The second lens group G2 may include three lenses. For example, the second lens group G2 may include the third lens 430, the fourth lens 440, and the fifth lens 450. The third lens 430 and the fourth lens 440 may each have positive refractive power, and may each have a convex object-side surface and a convex image-side surface. The fifth lens 450 may have negative refractive power, and may have a concave object-side surface and a convex image-side surface. The second lens group G2 may have positive refractive power as a whole.

The third lens group G3 may include two lenses. For example, the third lens group G3 may include the sixth lens 460 and the seventh lens 470. The sixth lens 460 may have positive refractive power and the seventh lens 470 may have negative refractive power. In addition, the sixth lens 460 may have a concave object-side surface and a convex image-side surface, and the seventh lens 470 may have a concave object-side surface and a concave image-side surface. The third lens group G3 may have negative refractive power as a whole.

The first to seventh lenses 410 to 470 may include lenses formed of a plastic material, and in particular, lenses constituting the second lens group G2 and the third lens group G3 among the first to seventh lenses 410 to 470 may be formed of a plastic material having a specific gravity of 2 g/cm³ or less. For example, the third to seventh lenses 430 to 470 may be formed of a plastic material having a specific gravity of 2 g/cm³ or less.

The second lens group G2 and the third lens group G3 may move in an optical axis direction to change a focal length and magnification of the optical imaging system 400. An optical axis distance between the first lens group G1 and the second lens group G2 and an optical axis distance between the second lens group G2 and the third lens group G3 may be inversely proportional to focal magnification of the optical imaging system 400. For example, the optical axis distance between the first lens group G1 and the second lens group G2 and the optical axis distance between the second lens group G2 and the third lens group G3 may be longer as the focal magnification of the optical imaging system 400 decreases, and may be shorter as the focal magnification of the optical imaging system 400 increases.

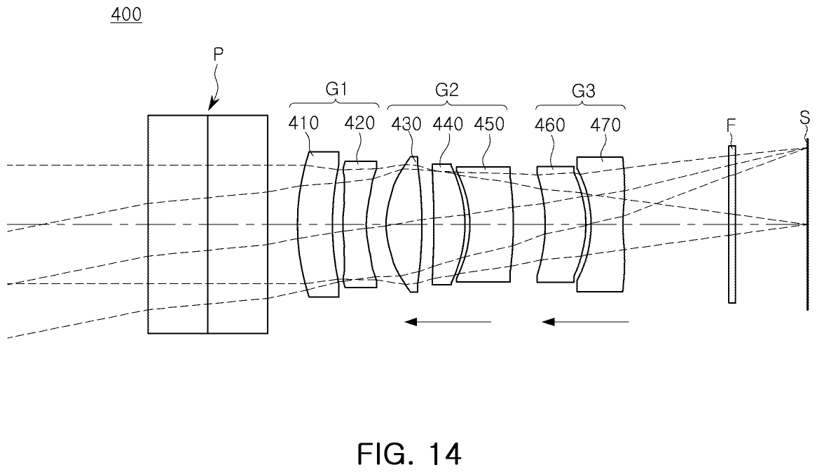

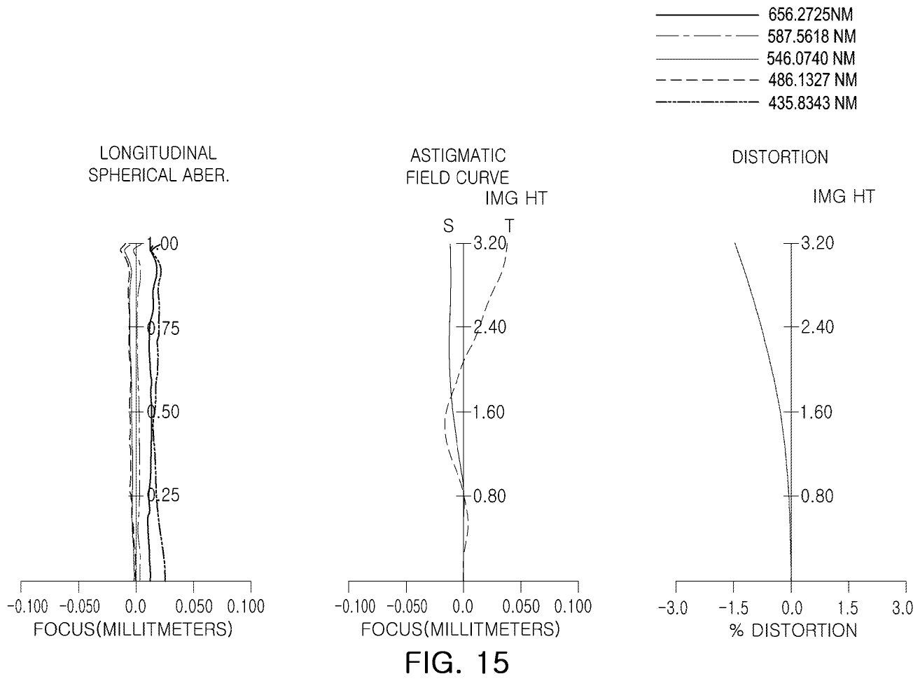

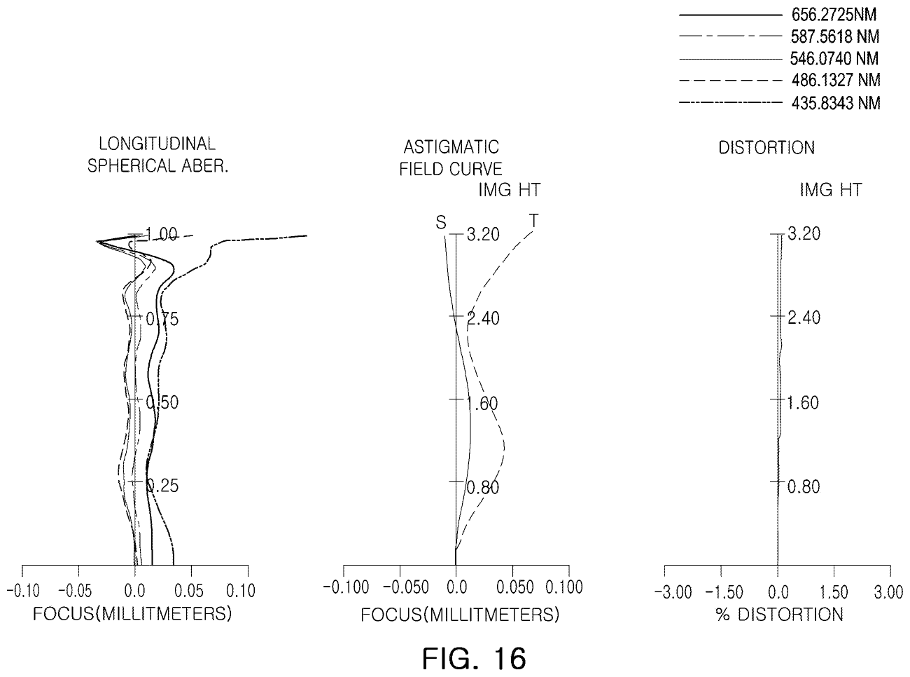

FIGS. 13 and 14 illustrate an optical imaging system at a wide-angle end and a telephoto end, respectively, and FIGS. 15 and 16 illustrate aberration characteristics of the optical imaging system according to the wide-angle end and the telephoto end, respectively.

The optical imaging system 400 according to a fourth embodiment of the present disclosure may further include a prism P, a stop, an infrared cut-off filter F, and an image sensor S.

The prism P may be disposed on an object side of the first lens 410. The prism P may refract or reflect a path of light incident to the optical imaging system 400. The stop may adjust an amount of light, and may be disposed between the first lens group G1 and the second lens group G2, for example, between the second lens 420 and the third lens 430. The filter F may be disposed in front of the image sensor S to block infrared rays included in the light incident to the optical imaging system 400. The image sensor S may include an imaging plane, and light passing through the first lens 410 to the seventh lens 470 may be incident on the imaging plane.

Table 7 below illustrates lens characteristics of the optical imaging system according to a fourth embodiment of the present disclosure, and Table 8 below is a table illustrating aspherical surface values of the optical imaging system according to a fourth embodiment of the present disclosure.

TABLE 7

| | | | Thickness/ | Thickness/ | | |
|---|---|---|---|---|---|---|
| Surface | | Radius of | distance | distance | Refractive | Abbe |
| No. | Reference | curvature | (Wide-angle end) | (Telephoto end) | index | number |
| 1 | Prism | Infinity | 2.400 | 2.400 | 1.717 | 29.5 |
| 2 | | Infinity | 2.400 | 2.400 | 1.717 | 29.5 |
| 3 | | Infinity | 1.200 | 1.200 | | |
| 4 | First lens | 15.898 | 1.499 | 1.499 | 1.661 | 20.4 |
| 5 | | 39.146 | 0.428 | 0.428 | | |
| 6 | Second lens | 10.196 | 0.892 | 0.892 | 1.544 | 56 |
| 7 | | 3.460 | 4.178 | 0.851 | | |
| 8(stop) | Third lens | 4.335 | 1.479 | 1.479 | 1.544 | 56 |
| 9 | | −23.332 | 0.451 | 0.451 | | |
| 10 | Fourth lens | 13.099 | 1.288 | 1.288 | 1.535 | 55.7 |
| 11 | | −5.705 | 0.203 | 0.203 | | |
| 12 | Fifth lens | −3.539 | 1.765 | 1.765 | 1.661 | 20.4 |
| 13 | | −8.584 | 1.873 | 1.301 | | |
| 14 | Sixth lens | −5.269 | 1.687 | 1.687 | 1.661 | 20.4 |
| 15 | | −4.580 | 0.205 | 0.205 | | |
| 16 | Seventh lens | −25.834 | 1.282 | 1.282 | 1.544 | 56 |
| 17 | | 6.617 | 1.001 | 4.399 | | |
| 18 | Filter | Infinity | 0.210 | 0.210 | 1.517 | 64.2 |
| 19 | | Infinity | 2.435 | 2.937 | | |
| 20 | Imaging plane | Infinity | 0.000 | 0.000 | | |

TABLE 8

| Surface | | | | | | | |
|---|---|---|---|---|---|---|---|
| No. | 4 | 5 | 6 | 7 | 8 | 9 | 10 |
| K | −24.880702 | −15.632449 | 11.0294056 | −5.9313539 | −0.2047220 | 71.1655691 | −97.096439 |
| A | 2.843E−03 | 1.911E−04 | −2.291E−02 | −7.936E−03 | 2.764E−04 | 3.036E−04 | 2.460E−03 |
| B | 1.735E−04 | 3.024E−03 | 7.854E−03 | 3.126E−03 | −2.523E−04 | 6.241E−04 | −7.582E−04 |
| C | −7.998E−05 | −1.374E−03 | −3.702E−03 | −1.739E−03 | 4.555E−04 | −8.126E−04 | −1.433E−03 |
| D | 1.093E−05 | 2.856E−04 | 1.344E−03 | 6.979E−04 | −3.468E−04 | 3.062E−040 | 7.015E−04 |
| E | 1.037E−06 | 1.263E−05 | −3.618E−04 | −1.826E−04 | 1.454E−04 | −4.500E−05 | −1.513E−04 |
| F | −5.898E−07 | −2.440E−05 | 6.863E−05 | 2.957E−05 | −3.654E−05 | −3.958E−06 | −1.576E−06 |
| G | 9.340E−08 | 6.489E−06 | −8.416E−06 | −2.611E−06 | 5.430E−06 | 2.511E−06 | 7.818E−06 |
| H | −6.912E−09 | −7.833E−07 | 5.841E−07 | 8.400E−08 | −4.394E−07 | −3.434E−07 | −1.401E−06 |
| J | 2.043E−10 | 3.789E−08 | −1.639E−08 | 1.538E−09 | 1.498E−08 | 1.618E−08 | 7.875E−08 |

| | 11 | 12 | 13 | 14 | 15 | 16 | 17 |
|---|---|---|---|---|---|---|---|
| K | −1.3738863 | −5.0369008 | −19.554803 | 3.72551203 | 2.18765576 | −50.516309 | 3.40725480 |
| A | 6.999E−03 | 3.098E−03 | 4.078E−03 | 1.462E−02 | 5.344E−03 | −2.991E−02 | −2.709E−02 |
| B | −1.651E−03 | −1.512E−03 | −3.458E−04 | −3.680E−03 | −6.431E−03 | −2.473E−03 | 5.272E−03 |
| C | −1.544E−03 | 3.835E−04 | 3.554E−04 | 3.583E−03 | 1.026E−02 | 9.625E−03 | −1.340E−03 |
| D | 1.526E−03 | 2.250E−04 | −2.465E−04 | −2.512E−03 | −7.434E−03 | −7.396E−03 | 3.243E−04 |
| E | −7.566E−04 | −2.316E−04 | 1.445E−04 | 1.230E−03 | 3.289E−03 | 3.271E−03 | −6.441E−05 |
| F | 2.142E−04 | 8.044E−05 | −5.625E−05 | −3.873E−04 | −9.184E−04 | −9.053E−04 | 8.640E−06 |
| G | −3.302E−05 | −1.255E−05 | 1.303E−05 | 7.473E−05 | 1.579E−04 | 1.533E−04 | −6.706E−07 |
| H | 2.482E−06 | 7.303E−07 | −1.634E−06 | −8.016E−06 | −1.530E−05 | −1.452E−05 | 2.386E−08 |
| J | −6.579E−08 | 5.962E−10 | 8.573E−08 | 3.682E−07 | 6.438E−07 | 5.933E−07 | −1.473E−10 |

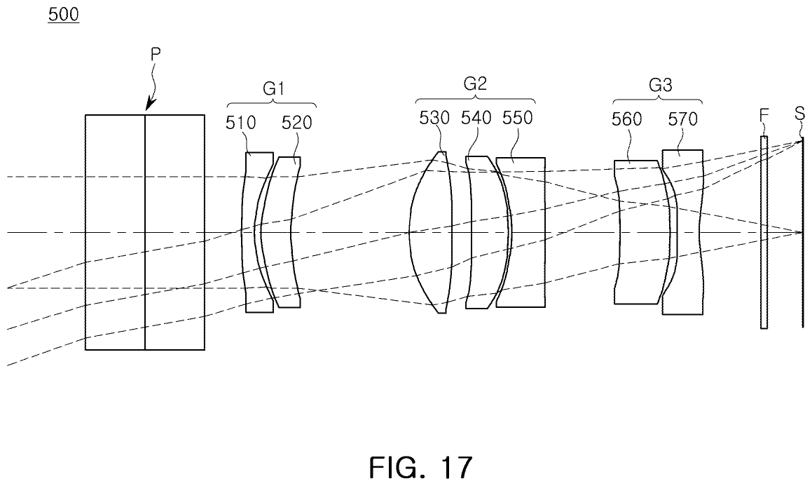

Next, an optical imaging system according to a fifth embodiment of the present disclosure will be described with reference to FIGS. 17 to 20.

An optical imaging system 500 according to a fifth embodiment of the present disclosure may include a first lens group G1, a second lens group G2, and a third lens group G3. The optical imaging system 500 may include a first lens 510, a second lens 520, a third lens 530, a fourth lens 540, a fifth lens 550, a sixth lens 560, and a seventh lens 570, sequentially disposed from an object side.

The first lens group G1 may include two lenses. For example, the first lens group G1 may include the first lens 510 and the second lens 520. The first lens 510 and the second lens 520 may have refractive power of different signs. For example, the first lens 510 may have negative refractive power, and the second lens 520 may have positive refractive power. In addition, both the first lens 510 and the second lens 520 may have a convex object-side surface and a concave image-side surface. The first lens group G1 may have negative refractive power as a whole.

The second lens group G2 may include three lenses. For example, the second lens group G2 may include the third lens 530, the fourth lens 540, and the fifth lens 550. The third lens 530 and the fourth lens 540 may each have positive refractive power. The third lens 530 may have a convex object-side surface and a convex image-side surface. The fourth lens 540 may have a concave object-side surface and a convex image-side surface. The fifth lens 550 may have negative refractive power, and may have a concave object-side surface and a convex image-side surface. The second lens group G2 may have positive refractive power as a whole.

The third lens group G3 may include two lenses. For example, the third lens group G3 may include the sixth lens 560 and the seventh lens 570. The sixth lens 560 may have positive refractive power and the seventh lens 570 may have negative refractive power. In addition, the sixth lens 560 may have a concave object-side surface and a convex image-side surface, and the seventh lens 570 may have a convex object-side surface and a concave image-side surface. The third lens group G3 may have negative refractive power as a whole.

The first to seventh lenses 510 to 570 may include lenses formed of a plastic material, and in particular, lenses constituting the second lens group G2 and the third lens group G3 among the first to seventh lenses 510 to 570 may be formed of a plastic material having a specific gravity of 2 g/cm³ or less. For example, the third to seventh lenses 530 to 570 may be formed of a plastic material having a specific gravity of 2 g/cm³ or less.

The second lens group G2 and the third lens group G3 may move in an optical axis direction to change a focal length and magnification of the optical imaging system 500. An optical axis distance between the first lens group G1 and the second lens group G2 and an optical axis distance between the second lens group G2 and the third lens group G3 may be inversely proportional to focal magnification of the optical imaging system 500. For example, the optical axis distance between the first lens group G1 and the second lens group G2 and the optical axis distance between the second lens group G2 and the third lens group G3 may be longer as the focal magnification of the optical imaging system 500 decreases, and may be shorter as the focal magnification of the optical imaging system 500 increases.

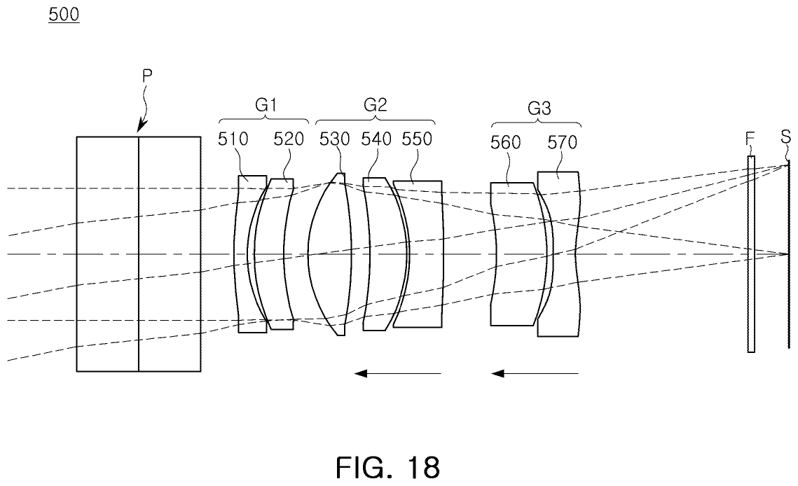

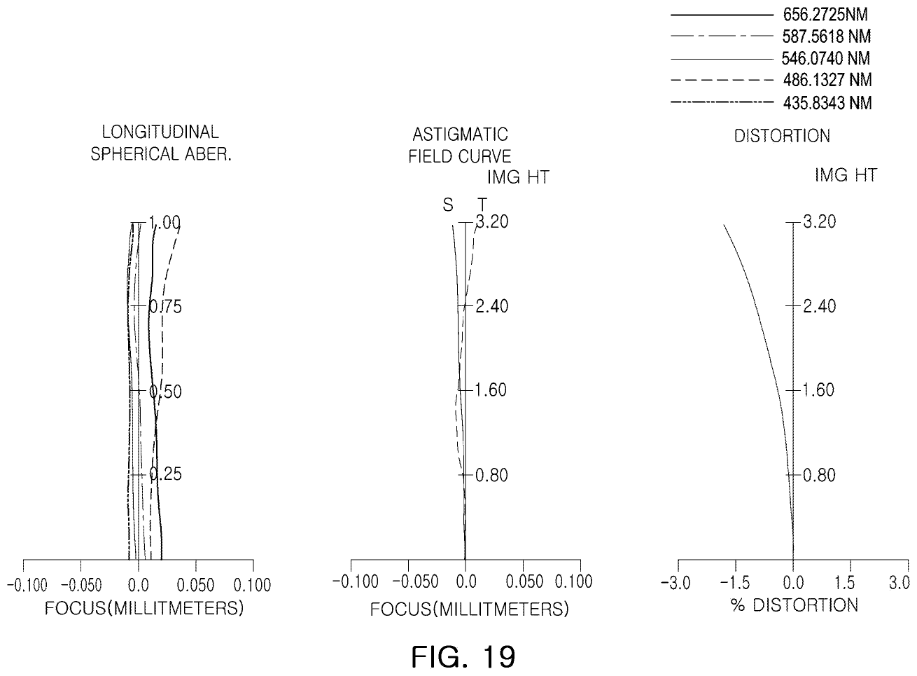

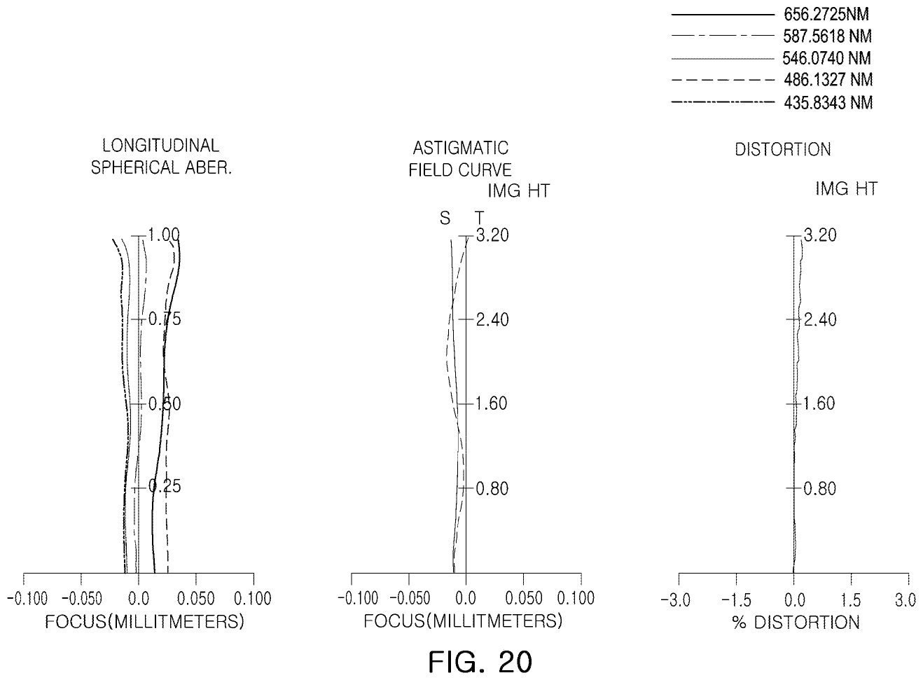

FIGS. 17 and 18 illustrate an optical imaging system at a wide-angle end and a telephoto end, respectively, and FIGS. 19 and 20 illustrate aberration characteristics of the optical imaging system according to the wide-angle end and the telephoto end, respectively.

The optical imaging system 500 according to a fifth embodiment of the present disclosure may further include a prism P, a stop, an infrared cut-off filter F, and an image sensor S.

The prism P may be disposed on an object side of the first lens 510. The prism P may refract or reflect a path of light incident to the optical imaging system 500. The stop may adjust an amount of light, and may be disposed between the first lens group G1 and the second lens group G2, for example, between the second lens 520 and the third lens 530. The filter F may be disposed in front of the image sensor S to block infrared rays included in the light incident to the optical imaging system 500. The image sensor S may include an imaging plane, and light passing through the first lens 510 to the seventh lens 570 may be incident on the imaging plane.

Table 9 below illustrates lens characteristics of the optical imaging system according to a fifth embodiment of the present disclosure, and Table 10 below is a table illustrating aspherical surface values of the optical imaging system according to a fifth embodiment of the present disclosure.

TABLE 9

| | | | Thickness/ | Thickness/ | | |
|---|---|---|---|---|---|---|
| Surface | | Radius of | distance | distance | Refractive | Abbe |
| No. | Reference | curvature | (Wide-angle end) | (Telephoto end) | index | number |
| 1 | Prism | Infinity | 2.400 | 2.400 | 1.717 | 29.5 |
| 2 | | Infinity | 2.400 | 2.400 | 1.717 | 29.5 |
| 3 | | Infinity | 1.200 | 1.200 | | |
| 4 | First lens | 12.092 | 0.450 | 0.450 | 1.544 | 56 |
| 5 | | 3.994 | 0.253 | 0.253 | | |
| 6 | Second lens | 4.815 | 1.026 | 1.026 | 1.635 | 24 |
| 7 | | 5.730 | 1.410 | 0.850 | | |
| 8(stop) | Third lens | 4.302 | 1.520 | 1.520 | 1.535 | 55.7 |
| 9 | | −12.357 | 0.679 | 0.679 | | |
| 10 | Fourth lens | −31.433 | 1.332 | 1.332 | 1.544 | 56 |
| 11 | | −5.075 | 0.058 | 0.058 | | |
| 12 | Fifth lens | −4.563 | 1.200 | 1.200 | 1.661 | 20.4 |
| 13 | | −14.042 | 2.593 | 1.872 | | |
| 14 | Sixth lens | −8.596 | 1.800 | 1.800 | 1.661 | 20.4 |
| 15 | | −5.600 | 0.224 | 0.224 | | |
| 16 | Seventh lens | 39.116 | 0.786 | 0.786 | 1.535 | 55.7 |
| 17 | | 3.784 | 2.159 | 6.159 | | |
| 18 | Filter | Infinity | 0.210 | 0.210 | 1.517 | 64.2 |
| 19 | | Infinity | 1.230 | 0.392 | | |
| 20 | Imaging plane | Infinity | 0.001 | 0.010 | | |

TABLE 10

| Surface No. | 4 | 5 | 6 | 7 | 8 | 9 | 10 |
|---|---|---|---|---|---|---|---|
| K | 3.11111840 | −1.7784013 | −2.2444869 | −2.451E+00 | −0.0278799 | −0.1736571 | 27.5900828 |
| A | −7.225E−04 | 3.883E−03 | −9.575E−04 | −4.469E−03 | 4.474E−05 | 4.066E−03 | 2.987E−03 |
| B | −8.175E−04 | −9.421E−04 | 1.013E−04 | 1.796E−04 | 4.105E−05 | −1.955E−04 | −4.843E−04 |
| C | 1.379E−04 | 2.619E−05 | −7.918E−05 | −5.224E−06 | 4.874E−06 | −1.065E−04 | −3.527E−04 |
| D | −9.204E−06 | 1.614E−05 | 1.096E−05 | −2.760E−06 | −4.487E−06 | 1.647E−05 | 6.165E−05 |
| E | 8.544E−08 | −1.808E−06 | −1.071E−07 | 4.650E−07 | 4.054E−07 | −5.716E−07 | −1.205E−06 |
| F | 1.285E−08 | 4.105E−08 | −5.161E−08 | −2.845E−08 | 0.000E+00 | 0.000E+00 | −2.079E−07 |
| G | 0.000E+00 | 0.000E+00 | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 | 0.000E+00 |

| | 11 | 12 | 13 | 14 | 15 | 16 | 17 |
|---|---|---|---|---|---|---|---|
| K | −1.9844845 | −11.470928 | −99 | −39.439249 | −10.715027 | 0 | −10.991784 |
| A | −9.219E−04 | −1.049E−02 | 8.391E−04 | −4.235E−04 | −1.228E−02 | −5.807E−02 | −2.811E−02 |
| B | 7.516E−04 | 3.766E−03 | 9.059E−04 | 4.190E−04 | 8.013E−03 | 2.105E−02 | 9.259E−03 |
| C | −4.005E−04 | −6.430E−04 | 1.030E−05 | 3.813E−04 | −3.688E−03 | −7.724E−03 | −2.872E−03 |
| D | 5.276E−05 | 4.251E−05 | −3.098E−05 | −3.862E−04 | 1.147E−02 | 2.161E−03 | 7.319E−04 |
| E | −1.592E−06 | −4.898E−07 | 3.336E−06 | 2.017E−04 | −2.252E−04 | −4.134E−04 | −1.378E−04 |
| F | −8.844E−08 | 0.000E+00 | 0.000E+00 | −6.307E−05 | 2.703E−05 | 5.260E−05 | 1.800E−05 |
| G | 0.000E+00 | 0.000E+00 | 0.000E+00 | 1.177E−05 | −1.898E−06 | −4.703E−06 | −1.541E−06 |
| H | 0.000E+00 | 0.000E+00 | 0.000E+00 | −1.212E−06 | 6.982E−08 | 3.114E−07 | 7.870E−08 |
| J | 0.000E+00 | 0.000E+00 | 0.000E+00 | 5.303E−08 | −9.739E−10 | −1.162E−08 | −1.830E−09 |

Tables 11 and 12 illustrate optical characteristics of the optical imaging system according to the embodiments of the present disclosure. Here, f1 is a focal length of a first lens, f2 is a focal length of a second lens, f3 is a focal length of a third lens, f4 is a focal length of a fourth lens, f5 is a focal length of a fifth lens, f6 is a focal length of a sixth lens, f7 is a focal length of a seventh lens, fG1 is a total focal length of a first lens group of an optical imaging system, PTTL is a distance along an optical axis from an object side of a prism as an optical path converter to an imaging plane, and EFL is an effective focal length of an optical imaging system.

TABLE 11

| | First | Second | Third | Fourth | Fifth |
|---|---|---|---|---|---|
| Reference | embodiment | embodiment | embodiment | embodiment | embodiment |
| f1 | 39.731 | 10.183 | 9.120 | 39.044 | −11.128 |
| f2 | −9.969 | 26.924 | 24.778 | −10.058 | 32.701 |
| f3 | 6.826 | −4.631 | −4.109 | 6.820 | 6.136 |
| f4 | 7.680 | 4.136 | 4.151 | 7.580 | 10.875 |
| f5 | −11.348 | −14.234 | −15.021 | −10.475 | −10.655 |
| f6 | 27.078 | −65.274 | 3735.101 | 26.455 | 19.375 |
| f7 | −9.548 | −21.855 | −15.607 | −9.509 | −7.861 |
| fG1 | −15.105 | −14.692 | −14.864 | −15.009 | −15.320 |
| fG2 | 6.005 | 6.701 | 6.070 | 6.104 | 6.570 |
| fG3 | −12.784 | −14.379 | −14.600 | −12.912 | −12.338 |

TABLE 12

| | First embodiment | | Second embodiment | | Third embodiment | | Fourth embodiment | | Fifth embodiment | |
|---|---|---|---|---|---|---|---|---|---|---|
| | Wide-angle | Telephoto | Wide-angle | Telephoto | Wide-angle | Telephoto | Wide-angle | Telephoto | Wide-angle | Telephoto |
| Reference | end | end | end | end | end | end | end | end | end | end |
| PTTL | 27.00 | 27.00 | 27.00 | 27.00 | 27.00 | 27.00 | 26.87 | 26.87 | 25.66 | 25.66 |
| TTL | 21.00 | 21.00 | 21.00 | 21.00 | 21.00 | 21.00 | 20.87 | 20.87 | 19.66 | 19.66 |
| BFL | 3.640 | 7.525 | 4.396 | 8.397 | 4.095 | 7.955 | 3.646 | 7.546 | 3.600 | 1.037 |
| EFL | 10.21 | 17 | 10.20 | 17 | 10.20 | 17 | 10.21 | 17 | 10.21 | 16.97 |
| FNO | 2.5 | 3.4 | 2.55 | 3.45 | 2.43 | 3.31 | 2.5 | 3.4 | 2.6 | 3.6 |
| FOV | 35.32 | 21.32 | 35.4 | 21.32 | 35.44 | 21.2 | 35.328 | 21.32 | 35.432 | 21.288 |

Table 13 below is a table illustrating values of Conditional Expressions 1 to 6 according to the first to fifth embodiments of the present disclosure.

TABLE 13

| Conditional | First | Second | Third | Fourth | Fifth |
|---|---|---|---|---|---|
| expression | embodiment | embodiment | embodiment | embodiment | embodiment |
| fw/ft | 0.601 | 0.600 | 0.600 | 0.601 | 0.602 |
| G2L1 | 56 | 56 | 56 | 56 | 55.7 |
| dtG12/dwG12 | 0.195 | 0.141 | 0.168 | 0.204 | 0.193 |
| FOVw/FOVt | 1.657 | 1.660 | 1.672 | 1.657 | 1.664 |
| \| fG2/fG3 \| | 0.470 | 0.466 | 0.416 | 0.473 | 0.533 |
| FNOt | 3.4 | 3.45 | 3.31 | 3.4 | 3.6 |

As set forth above, according to one or more embodiments of the present disclosure, in an optical imaging system, focal length and magnification may be continuously adjusted, and a bright image at a long focal length at a telephoto end may be obtained.

In addition, the optical imaging system according to one or more embodiments of the present disclosure may be manufactured at a relatively low cost because the optical imaging system may be composed only of lenses formed of a plastic material.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens group having negative refractive power;
a second lens group having positive refractive power; and
a third lens group having negative refractive power,
wherein the second lens group and the third lens group are configured to move in an optical axis direction to adjust a focal length and magnification, and the following conditional expression is satisfied,
FNOt≤3.6,
where FNOt is an F value at a telephoto end of the optical imaging system.

2. The optical imaging system of claim 1, further comprising:
a stop disposed between the first lens group and the second lens group.

3. The optical imaging system of claim 1, further comprising:
an optical path convertor disposed on an object side of the first lens group.

4. The optical imaging system of claim 1, wherein the first and second lens groups each comprise two or three lenses,
wherein a first lens of the second lens group has positive refractive power.

5. The optical imaging system of claim 1, wherein a first lens of the second lens group satisfies the following conditional expression,
55<G2L1,
where G2L1 is an Abbe number of the first lens of the second lens group.

6. The optical imaging system of claim 1, wherein the following conditional expression is satisfied,
fw/ft<0.7,
where fw is a focal length at a wide-angle end of the optical imaging system, and ft is a focal length at a telephoto end of the optical imaging system.

7. The optical imaging system of claim 1, wherein the following conditional expression is satisfied,
dtG12/dwG12<0.3,
where dtG12 is a distance between the first lens group and the second lens group at a telephoto end of the optical imaging system, and dwG12 is a distance between the first lens group and the second lens group at a wide-angle end of the optical imaging system.

8. The optical imaging system of claim 1, wherein the following conditional expression is satisfied,
1.6<FOVw/FOVt,
where FOVw is a field of view at a wide-angle end of the optical imaging system, and FOVt is a field of view at a telephoto end of the optical imaging system.

9. The optical imaging system of claim 1, wherein the following conditional expression is satisfied,

|fG2/fG3|<0.6,
where fG2 is a total focal length of the second lens group of the optical imaging system, and fG3 is a total focal length of the third lens group of the optical imaging system.

10. An optical imaging system, comprising:
a first lens, a second lens, a third lens, a fourth lens, a fifth lens, a sixth lens, and a seventh lens sequentially disposed from an object side, forming first, second, and third lens groups sequentially disposed from an object side,
wherein at least a portion of the first to seventh lenses are formed of a plastic material,
wherein an optical axis distance between the first lens group and the second lens group, and an optical axis distance between the second lens group and the third lens group are configured to vary.

11. The optical imaging system of claim 10, wherein the first lens group comprises two or three lenses, and the third lens group comprises two lenses.

12. The optical imaging system of claim 10, wherein the lenses included in the second and third lens groups have a specific gravity of 2 g/cm³.

13. The optical imaging system of claim 10, wherein at least one of the third lens and the fourth lens has positive refractive power.

14. The optical imaging system of claim 10, wherein the second lens has refractive power of a sign, opposite to that of at least one of the first lens or the third lens.

15. The optical imaging system of claim 10, wherein the first, second, and third lens groups sequentially have negative, positive, and negative refractive power.

16. The optical imaging system of claim 10, wherein the following conditional expression is satisfied,
FNOt≤3.6,
where FNOt is an F value at a telephoto end of the optical imaging system.

17. An optical imaging system, comprising:
a first lens, a second lens, a third lens, a fourth lens, a fifth lens, a sixth lens, and a seventh lens sequentially disposed from an object side, forming first, second, and third lens groups sequentially disposed from an object side; and
an optical path convertor disposed on an object side of the first lens group,
wherein the first lens has a positive refractive power,
wherein the second lens group and the third lens group are configured to move in an optical axis direction to adjust a focal length and magnification, and
wherein the first lens group is fixed in an optical axis direction.

18. The optical imaging system of claim 17, wherein at least a portion of the first to seventh lenses are formed of a plastic material.

19. The optical imaging system of claim 10, wherein the first lens group comprises two or three lenses, and the third lens group comprises two lenses, and
wherein the lenses included in the second and third lens groups have a specific gravity of 2 g/cm³ or less.

20. The optical imaging system of claim 17, wherein the following conditional expression is satisfied,
FNOt≤3.6,
where FNOt is an F value at a telephoto end of the optical imaging system.
